(19) United States
(12) Patent Application Publication
(10) Pub. No.: US 2026/0177887 A1
(43) Pub. Date: Jun. 25, 2026

(54) ELECTRONIC APPARATUS

(71) Applicant: CANON KABUSHIKI KAISHA, Tokyo (JP)

(72) Inventor: YOSHIHIKO FUJISE, Kanagawa (JP)

(21) Appl. No.: 19/407,405

(22) Filed: Dec. 3, 2025

(30) Foreign Application Priority Data
Dec. 24, 2024 (JP) 2024-227781

(51) Int. Cl. G03B 17/55; H04N 25/617

(52) U.S. Cl. CPC G03B 17/55; H04N 25/617

(57) ABSTRACT

One or more electronic apparatuses may include a circuit board, a control board configured to control the circuit board, a connecting component including a conductor layer that electrically connects the circuit board and the control board, and sheet metal thermally connected to the circuit board and having a fixing portion that fixes the connecting component. An opening is provided in an area of the fixing portion facing the conductor layer. The sheet metal includes at least one thermal connector that electrically and thermally connects the circuit board and the control board. Thermal resistance between the circuit board and the control board is higher than that between the circuit board and the fixing portion.

### BACKGROUND

### Field of the Technology

The aspect of the disclosure relates to one or more embodiments of an electronic apparatus having a ground noise countermeasure.

### Description of the Related Art

Electronic apparatuses are demanded to suppress noise and achieve effective heat dissipation. Japanese Patent Application Laid-Open No. 2021-190953 discloses a structure that takes electrical measures by providing a plurality of openings in sheet metal that is used for heat dissipation, in order to solve EMI problems caused by electrical coupling that occurs in a case where a flexible printed circuit (board) (FPC) comes into contact with a metal plate.

The structure disclosed in Japanese Patent Application Laid-Open No. 2021-190953 may reduce the heat capacity of the sheet metal and lower heat dissipation performance.

### SUMMARY

One or more embodiments of an electronic apparatus according to one or more aspects of the disclosure may include a circuit board, a control board configured to control the circuit board, a connecting component including a conductor layer that electrically connects the circuit board and the control board, and sheet metal thermally connected to the circuit board and having a fixing portion that fixes the connecting component. An opening is provided in an area of the fixing portion facing the conductor layer. The sheet metal includes at least one thermal connector that electrically and thermally connects the circuit board and the control board. Thermal resistance between the circuit board and the control board is higher than that between the circuit board and the fixing portion.

One or more embodiments of an electronic apparatus according to another aspect of the disclosure may include a circuit board, a control board configured to control the circuit board, a connecting component including a conductor layer that electrically connects the circuit board and the control board, sheet metal thermally connected to the circuit board and having a fixing portion that fixes the connecting component, and an insulating layer disposed between the conductor layer and an area of the fixing portion facing the conductor layer. The sheet metal includes at least one thermal connector that electrically and thermally connects the circuit board and the control board. Thermal resistance between the circuit board and the control board is higher than that between the circuit board and the fixing portion.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configuration of a digital camera, which is an example of an electronic apparatus according to a first embodiment.

FIGS. 2A and 2B are external perspective views of the digital camera according to the first embodiment.

FIG. 3 is an exploded perspective view of the digital camera according to the first embodiment.

FIGS. 4A, 4B, 4C, and 4D explain a battery chamber unit according to the first embodiment.

FIGS. 5A and 5B explain the battery chamber unit according to the first embodiment.

FIG. 6 explains a battery chamber unit according to a second embodiment.

FIG. 7 explains a battery chamber unit according to a third embodiment.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

### First Embodiment

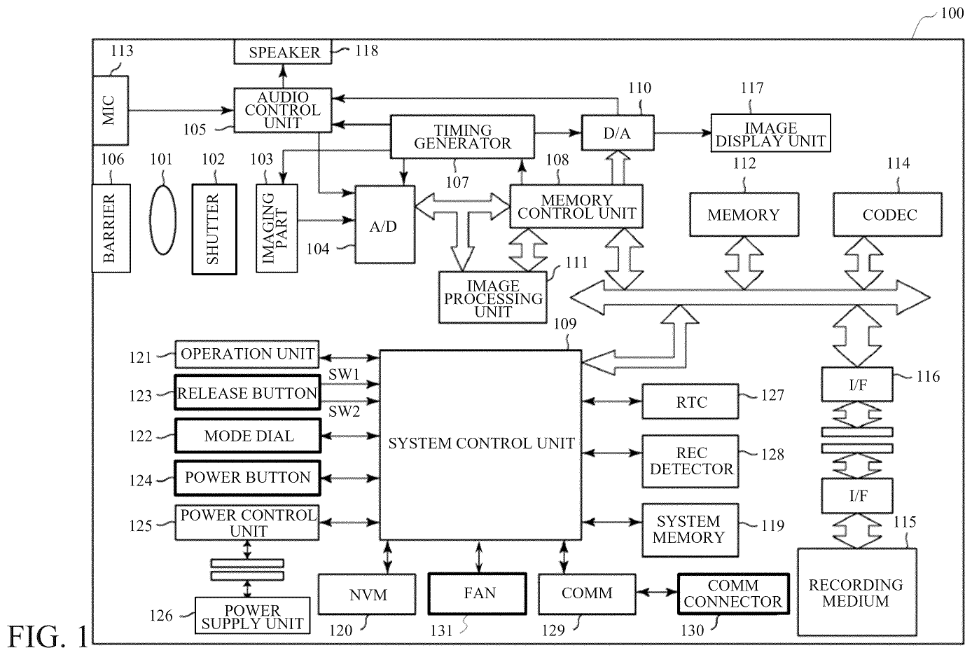

FIG. 1 is a block diagram illustrating the configuration of a digital camera 100, which is an example of an electronic apparatus according to this embodiment. The disclosure is applicable to a variety of electronic apparatuses, such as smartphones, personal computers, tablet devices, game machines, head-mounted displays, drones, automobiles, and their peripheral devices.

The digital camera 100 includes an optical system. The optical system includes an imaging lens 101, a shutter 102 with an aperture stop function, and an imaging part 103.

The imaging part 103 includes an image sensor 306, an imaging substrate 305 for transmitting a converted electrical signal, and an imaging FPC 307.

An A/D converter 104 is used to convert an analog signal output from the imaging part 103 into a digital signal, and to convert an analog signal output from an audio control unit 105 into a digital signal.

A lens barrier 106 covers the imaging lens 101 to reduce dirt and damage to the imaging lens 101.

A timing generator 107 is controlled by a memory control unit 108 and a system control unit 109, and supplies a clock signal and a control signal to the imaging part 103, audio control unit 105, A/D converter 104, and D/A converter 110.

An image processing unit 111 performs predetermined pixel interpolation, resizing such as reduction, and color conversion processing on the output data from the A/D converter 104 and the data stored in a memory 112. The image processing unit 111 also performs predetermined calculations on the captured image data, and the system control unit 109 controls exposure and focus detection based on the obtained calculation result. This allows through-the-lens (TTL) autofocus (AF) processing, auto-exposure (AE) processing, and pre-flash emission (EF) processing to be performed. The image processing unit 111 performs predetermined calculations using the captured image data, and TTL auto white balance (AWB) processing based on the obtained calculation result.

The output data from the A/D converter 104 is written into the memory 112 via the image processing unit 111 and the memory control unit 108, or directly via the memory control unit 108.

The memory 112 stores information accompanying images, such as audio data recorded by a microphone 113, captured still and moving images, and file headers in a case where an image file is constructed. The memory 112 has sufficient storage capacity to store a predetermined number of still images, and a moving image and audio data for a predetermined time.

The compression/decompression unit (CODEC) 114 compresses and decompresses image data using technologies such as adaptive discrete cosine transform (ADCT), and is triggered by the shutter 102 to read a captured image stored in the memory 112, perform compression processing, and write the processed data to the memory 112. It also reads a compressed image from the memory 112, which came from a recording medium 115, etc., performs decompression processing, and writes the processed data to the memory 112.

The image data written into the memory 112 by the CODEC 114 is converted into a file by a file processing unit of system control unit 109 and recorded on the recording medium 115 via a recording medium I/F 116.

The memory 112 also serves as a memory for image display, and the display image data written into the memory 112 is displayed on an image display unit 117 via the D/A converter 110.

An audio signal output from the microphone 113 is converted into a digital signal by the A/D converter 104 via the audio control unit 105, which includes an amplifier etc., and then stored in the memory 112 by the memory control unit 108.

The audio data recorded on the recording medium 115 is read into the memory 112, and then passed through the D/A converter 110 to be processed in the audio control unit 105, and the signal is output by speaker 118.

The system control unit 109 is a control unit that can comprehensively control digital camera 100 and each component attached to the digital camera 100. The system control unit 109 is connected to a nonvolatile memory (NVM) 120 and a system memory 119.

The nonvolatile memory 120 is a nonvolatile storage element that stores programs for operating the system control unit 109, a variety of adjustment parameters, etc. The programs read from the nonvolatile memory 120 are loaded to the system memory 119, a volatile storage element, and executed.

The system memory 119 is a so-called frame memory, and is a memory that temporarily stores image signals and can be read out when needed. In addition to image signals, the system memory 119 can also store constants, variables, programs, etc. for the operation of the system control unit 109.

A shutter switch (SW1), a shutter switch (SW2), and an operation unit 121 are operation units that the user uses to input a variety of operation instructions into the system control unit 109.

The operation unit 121 includes a variety of operation members such as a menu button and a jog dial, and can display a captured image on the image display unit 117 and configure a variety of settings. In a case where the menu button is pressed, a menu screen that allows a variety of settings to be made is displayed on the image display unit 117. The user can intuitively make a variety of settings using the menu screen displayed on the image display unit 117 and the operation unit 121. The touch of the user's finger or pen on the image display unit 117 may also be detected, and the icon displayed on the image display unit 117 may be similarly interpreted as the operation of a switch or dial, such as a button or dial. An operation member that can detect the rotation of a jog dial or other such device may be used to perform operations similar to those of a bidirectional key.

A mode dial 122 is used by the user to switch the operating mode of the system control unit 109 between a still image capturing mode, a continuous shooting (imaging) mode, a moving image capturing mode, a playback mode, etc.

The shutter switch (SW1) is turned on when the release button 123 on the digital camera 100 is half-pressed (being operated). It then instructs the start of operations such as AF, AE, AWB, and EF.

The shutter switch (SW2) is turned on when the release button 123 is fully pressed (completely operated), and instructs the start of a series of imaging processing, from reading a signal from the imaging part 103 to writing image data into the recording medium 115.

A power button 124 is an operation member for switching between the power on and off.

A power control unit 125 includes a battery detection circuit, a DC-DC converter, and a switch circuit that switches between blocks to be powered, and detects whether a battery is installed, the battery type, and the remaining battery level. It also controls the DC-DC converter based on the detection result and instruction from the system control unit 109, and supplies the required voltage to each electrical element, including the system control unit 109, for a required period.

A power supply unit 126 includes a primary battery such as an alkaline battery or a lithium battery, a secondary battery such as a NiCd battery, a NiMH battery, or a Li-ion battery, an AC adapter, etc. The power supply unit 126 is connected to the power control unit 125 via a camera-side power connector.

A Real Time Clock (RTC) 127 has an internal power supply separate from the power control unit 125, and continues to keep time even if the power supply unit 126 has gone down.

The system control unit 109 controls the timer using the date and time obtained from the RTC 127 at startup.

A recording medium attachment/detachment (REC) detector 128 detects whether or not the recording medium 115 is attached to the digital camera 100.

The communication unit (COMM) 129 performs various communication processing such as RS232C, USB, IEEE1394, P1284, SCSI, modem, LAN, and wireless communication.

A communication (COMM) connector 130 (or an antenna in the case of wireless communication) connects the digital camera 100 to other devices via the communication unit 129.

The drive (rotation/stop and rotation speed) of a fan 131 is controlled by the system control unit 109.

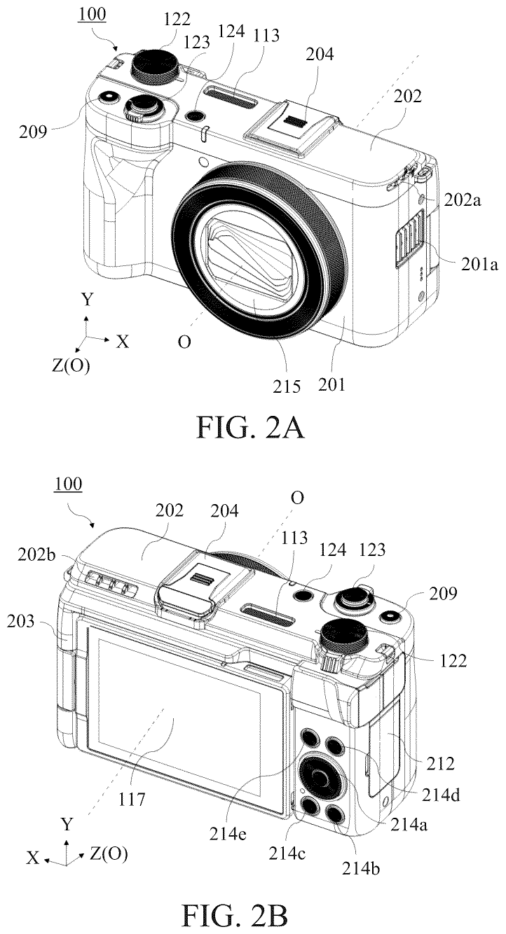

FIGS. 2A and 2B are external oblique views of the digital camera 100. FIGS. 2A and 2B are perspective views of the digital camera 100 viewed from the front side (object side) and rear side (image side), respectively. An axis parallel to an optical axis O of the digital camera 100 is defined as a Z-axis, a height direction is defined as a Y-axis, and a width direction (horizontal direction) is defined as an X-axis. These X-axis, Y-axis, and Z-axis will be used in the other figures as well.

The exterior of the digital camera 100 is formed by a front cover 201, a top cover 202, a rear cover 203, and a terminal cover 212 that opens and closes the communication connector 130.

A lens unit 215, which is an optical system, is provided on the front side of the digital camera 100. The lens unit 215 includes the imaging lens 101, the shutter 102, and the imaging part 103. The lens unit 215 may be integrated with the digital camera 100 or may be attachable to and detachable from the digital camera 100.

The top surface of the digital camera 100 includes a release button 123, a power button 124, a mode dial 122, a moving image capturing button 209, the microphone 113 for picking up external sounds, an accessory shoe 204, and the like.

As illustrated in FIG. 2B, the image display unit 117 including an LCD or the like is provided on the back side of the digital camera 100. When viewing the digital camera 100 from the rear side, a plurality of operation buttons 214a, 214b, 214c, 214d, and 214e that constitute the operation unit 121 are provided on the right side of the image display unit 117.

The front cover 201 includes an intake port 201a for the fan 131. The top cover 202 is provided with exhaust ports 202a and 202b for the fan 131. The exhaust port 202a is provided on a side surface of the digital camera 100 opposite the side closest to an operation system such as the release button 123, across the accessory shoe 204. The exhaust port 202b is designed to exhaust air toward the rear of the digital camera 100.

In a case where the fan 131 rotates, air flows into the interior of the digital camera 100 through the intake port 201a, and the air is then exhausted through the exhaust ports 202a and 202b. The exhaust direction of the exhaust port 202a is a side surface direction (+X direction) opposite to the microphone 113 so that the exhaust air does not hit the microphone 113. The exhaust direction of exhaust port 202b is toward the rear of the digital camera 100 (−Z direction).

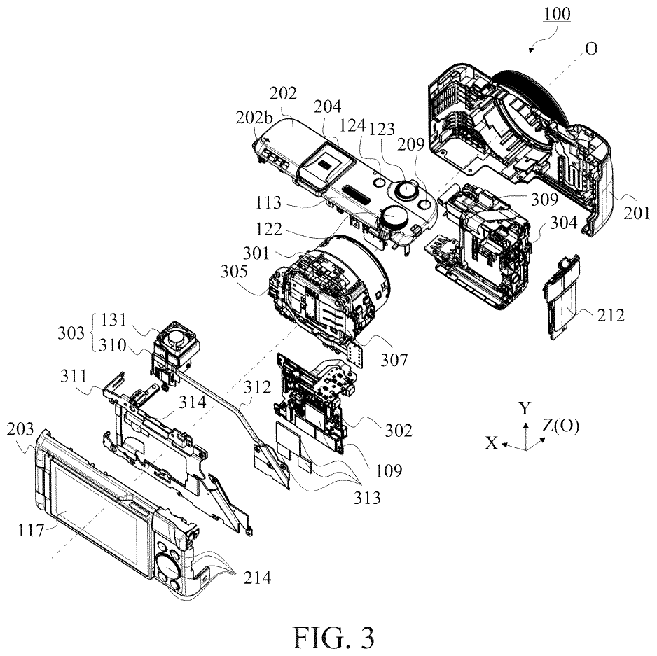

FIG. 3 is an exploded perspective view of the digital camera 100. As discussed, the exterior of the digital camera 100 is formed by the front cover 201, top cover 202, rear cover 203, and terminal cover 212.

Provided inside the digital camera 100 are components such as the imaging unit 301, a main substrate (control board) 302, a cooling unit 303, and a battery chamber unit 304.

The main substrate 302 is mounted with the system control unit 109 and a plurality of electronic elements.

The imaging unit 301 includes the imaging lens 101, the shutter 102, the imaging part 103, and the lens barrier 106.

The imaging substrate 305 is exposed on the back surface (−Z direction) of the imaging unit 301. The image sensor 306 is a charge-accumulation solid-state image sensor such as a CMOS that receives a light beam from an object guided by the imaging lens 101 and converts it into an electrical image signal. The image sensor 306 is mounted on the surface of the imaging substrate 305 facing the front of the digital camera 100. The imaging substrate 305 controls the voltage used to drive the image sensor 306 and transmits the imaging signal output from the image sensor 306 to the main substrate 302 via the imaging FPC 307.

The battery chamber unit 304 holds the power supply unit 126 and an antenna substrate (circuit board) 401 (described below) and supplies power to the main substrate 302 via a power FPC 309.

The cooling unit 303 includes a fan 131 and a duct 310. The duct 310 has two openings, one connected to the intake port 201a and the other connected to the exhaust ports 202a and 202b via the fan 131.

A main chassis 311 is a sheet metal member that extends in the X direction of the digital camera 100, secures the rigidity of the digital camera 100, and holds the cooling unit 303 and a heat pipe 312 using screws. The heat pipe 312 is a heat transfer member for transferring heat from the system control unit 109 to the cooling unit 303. Three thermally conductive rubber pieces 313 are arranged between the heat pipe 312 and the system control unit 109, and heat from the system control unit 109 is transferred to the cooling unit 303 via the thermally conductive rubber pieces 313 and the heat pipe 312.

The imaging part 103 is thermally connected to the cooling unit 303 via a duct-side graphite sheet 314, and heat from the imaging part 103 is transferred to the cooling unit 303 via the duct-side graphite sheet 314.

The imaging unit 301 and battery chamber unit 304 are fixed to the front cover 201 with screws. The main substrate 302 and main chassis 311 are also fixed to the battery chamber unit 304 with screws.

Thus, the heat pipe 312 is fixed to the main chassis 311 with screws, and is therefore fixed to the battery chamber unit 304 together with the main chassis 311.

Due to the above structure, a heat dissipation path is formed via the heat pipe 312 to the system control unit 109 and the cooling unit 303 of the imaging part 103.

The heat transferred to the cooling unit 303 is discharged to the outside of the digital camera 100 by the fan 131.

While the digital camera 100 in this embodiment uses the heat pipe 312, heat conductive rubber 313, and duct side graphite sheet 314 as heat transfer members, the disclosure is not limited to this embodiment. For example, sheet metal made of a metal material with high thermal conductivity such as aluminum, copper, or magnesium may also be used.

Among the components of the digital camera 100, the system control unit 109 and the imaging part 103 consume particularly large amounts of power and generate a large amount of heat, their temperatures are likely to rise. Therefore, the image capturable time with the digital camera 100 is limited by the guaranteed operating temperatures of the system control unit 109 and the imaging part 103, excluding the remaining battery level. To extend the image capturable time, the system control unit 109 and the imaging part 103 may be cooled so that their temperatures do not exceed the guaranteed operating temperatures. Hence, the digital camera 100 according to this embodiment has the above heat dissipation structure. By exhausting the heat from the system control unit 109 and the imaging part 103 transmitted to the duct 310 using the fan 131, the system control unit 109 and the imaging part 103 are forcibly air-cooled, and temperature rises are prevented.

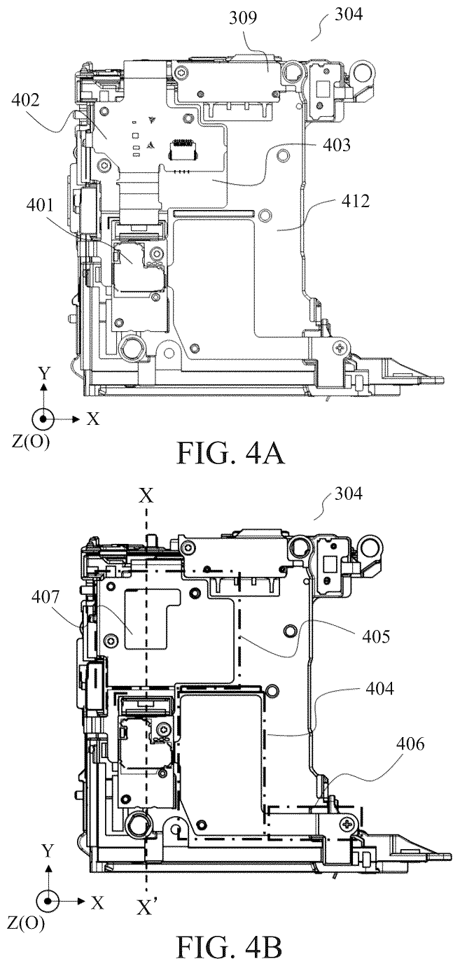

FIGS. 4A, 4B, 4C, and 4D explain the battery chamber unit 304. FIG. 4A is a front view of the battery chamber unit 304. FIG. 4B is a front view of the battery chamber unit 304 with the connection substrate (connecting component) 402 removed. FIG. 4C is a sectional view and an enlarged cross-section taken along line X-X′ in FIG. 4B. FIG. 4D is an exploded perspective view of the battery chamber unit 304 and its surrounding components. The enlarged cross-section of FIG. 4C omits components not directly related to the generation of stray capacitance between conductors, such as the antenna substrate, main substrate, thermal connection, and intermediate members for simplicity and ease of understanding.

The battery chamber unit 304 is a unit in which the power FPC 309, antenna substrate 401, and connection substrate 402 connecting the signal lines of the antenna substrate 401 to the main substrate 302 are attached to a battery chamber (structure) 412.

In this embodiment, the antenna substrate 401 is a printed circuit board equipped with an antenna circuit and an IC chip (integrated circuit). Since the IC chip mounted on the antenna substrate 401 generates heat, heat dissipation sheet metal 403 is provided on the battery chamber unit 304 to cool the IC chip. The antenna substrate 401 and heat dissipation sheet metal 403 are thermally connected in the Z direction by a heat conductive component 415. In this embodiment, the heat conductive component 415 is heat conductive rubber, but it may also be a graphite sheet or the like.

In this embodiment, the connection substrate 402 is an FPC. The connection substrate 402 is disposed adjacent to the heat dissipation sheet metal 403 and is fixed at the installation portion (fixing portion) 405 of the heat dissipation sheet metal 403 with an adhesive member 416 such as double-sided tape. This structure can reduce contact with surrounding components that may occur due to vibration or impact inside the digital camera 100, as well as noise caused by electric disconnection from the main substrate 302 and antenna substrate 401 and vibration of signal lines.

The heat dissipation sheet metal 403 is electrically connected to the main substrate 302 by screws or conductor contacts, and is connected to the ground terminal of the digital camera 100. Thereby, a shielding effect that blocks electromagnetic waves can be provided.

In a case where multiple different signal lines are arranged in parallel, coupling phenomenon may occur. The coupling phenomenon is a transmission phenomenon of electromagnetic energy between adjacent conductors, resulting in unintended stray capacitance Cs, which may cause noise and signal interference within the digital camera 100. The stray capacitance Cs is calculated using the following equation (1):

$$Cs = \frac{ε A}{d 1} \qquad ( 1 )$$

where ε is a dielectric constant, A is an area facing the conductor, and d1 is a distance between the conductors.

The greater the dielectric constant ε is, the larger the area facing the conductor A is, and the smaller the distance d1 between the conductors is, the greater the stray capacitance Cs is and the greater the likelihood of noise and signal interference is.

High-frequency signals, especially RF signals, have short wavelengths, so a distance between signal lines is often long relative to the wavelength, and the coupling phenomenon is more likely to occur. Therefore, in designing circuits that manage RF signals, it is important to take measures to suppress the coupling phenomenon, such as signal line placement and the use of ground (GND) shielding.

Due to the recent miniaturization and high density demands of electronic components inside digital camera 100, the area A facing the conductor increases and it becomes difficult to increase the distance d between the conductors.

This embodiment fixes the connection substrate 402 relative to the installation portion 405. Thereby, unintended stray capacitance Cs may occur between the conductor of the installation portion 405 and the opposing conductor of a conductor layer 411, which includes the signal pattern 409 and GND pattern 410 of the connection substrate 402.

In addition, the impedance matching of the signal pattern 409 of the antenna substrate 401, which carries the RF wave signal inside the connection substrate 402, can be disrupted to cause noises, and the antenna characteristic may deteriorate.

This embodiment forms, as illustrated in FIG. 4B, an opening 407 in the area of the installation portion 405 facing the conductor layer 411. The opening 407 can reduce the area of the installation portion 405 facing the conductor layer 411, as illustrated in FIG. 4C, and suppress the electrical noise impact on the antenna substrate 401 due to the generation of unintended stray capacitance Cs. The opening 407 provided in the heat dissipation sheet metal 403 can reduce the stray capacitance Cs, but it may reduce the heat dissipation area of the heat dissipation sheet metal 403, and consequently degrade the heat dissipation performance of the digital camera 100 as a whole. As discussed above, the heat dissipation sheet metal 403 is sheet metal that is connected to the GND of the digital camera 100 and has a shielding effect for blocking electromagnetic waves. Therefore, in a case where a plurality of openings are provided as in Japanese Patent Application Laid-Open No. 2021-190953, or the opening 407 is provided as illustrated in FIGS. 4A, 4B, 4C, and 4D, the current return path may change or a detour may be required. As a result, impedance may increase, noise may be likely to occur, the EMI characteristic deteriorates, and the shielding effect of the GND sheet metal lowers.

As illustrated in FIG. 4D, the main substrate 302 is attached to the battery chamber unit 304 via screws or the like, similarly to the heat dissipation sheet metal 403. The heat dissipation sheet metal 403 has at least one thermal connector 406 that electrically and thermally connects the antenna substrate 401 and the main substrate 302. As illustrated in FIG. 4B, the heat dissipation sheet metal 403 may have a heat dissipation portion 404 between the antenna substrate 401 and the thermal connector 406 to enhance the cooling effect of the antenna substrate 401. The heat dissipation portion 404 may have a larger volume and heat capacity than those of the installation portion 405. Thereby, heat can be more actively dissipated to the heat dissipation portion 404, which has a larger heat capacity, rather than the installation portion 405, which has a smaller heat capacity.

The thermal resistance R between the antenna substrate 401 and the main substrate 302 is set higher (higher) than between the antenna substrate 401 and the installation portion 405. This allows for electrical connection while preventing heat from flowing from the main substrate 302, which includes the system control unit 109 (one of the main heat sources), to the heat dissipation portion 404, which has a larger heat capacity. The thermal resistance R is calculated using the following equation (2):

$$R = \frac{d 2}{λ} \qquad ( 2 )$$

where d2 is a distance in the heat transfer direction, and λ is the thermal conductivity of the material.

The greater the distance d2 in the heat transfer direction is and the greater the thermal conductivity λ is, the greater the thermal resistance R is.

In this embodiment, as illustrated in FIG. 4D, between the antenna substrate 401 and the main substrate 302, the width A of the thermal connector 406 in the heat transfer direction is approximately ⅙ times as long as the width B of the heat dissipation portion 404 in the heat transfer direction. This reduces the cross-sectional area in the heat transfer direction, increasing the thermal resistance R of the thermal connector 406 compared to that of each of the heat dissipation portion 404 and the installation portion 405.

By placing an intermediate member between the antenna substrate 401 and the main substrate 302, the thermal resistance R is set to be large.

This structure creates a path for actively dissipating heat from the antenna substrate 401 to the heat dissipation portion 404, which has a greater heat capacity than that of the installation portion 405, while suppressing the inflow of heat from the main substrate 302 into the heat dissipation portion 404.

In this embodiment, in addition to the heat dissipation portion 404 and the thermal connector 406, a first intermediate member 408 and a second intermediate member 414 are arranged between the antenna substrate 401 and the main substrate 302, in this order from the closest to the thermal connector 406. The first intermediate member 408 may be a component with a large heat capacity, and have thermal conductivity equivalent to that of the thermal connector 406, and may be a molded or machined component made of a metal that is both an electrically conductive member and a thermally conductive member. The second intermediate member 414 may be a component with a high thermal resistance, and may be made of a material with a lower thermal conductivity than that of each of the thermal connector 406 and the first intermediate member 408. As long as there are screws or the like electrically connecting the first intermediate member 408 to a grounded (GND) plate 413 separate from the heat dissipation sheet metal 403, the second intermediate member 414 may be made of a nonconductive mold material or the like. Due to this structure, the second intermediate member 414 can reduce heat inflow from the main substrate 302. Furthermore, the large heat capacity of the first intermediate member 408 creates a path for heat to escape from the antenna substrate 401 via the heat dissipation portion 404 and the thermal connector 406. The first intermediate member 408 also functions as a heat accumulation material that accumulates heat transmitted from the main substrate 302 via the second intermediate member 414 and prevents it from flowing into the heat dissipation sheet metal 403. In a case where an electrical connection can be made between the heat dissipation sheet metal 403 and the GND plate 413, a strong ground connection can also be made.

While this embodiment provides two intermediate members, the number of intermediate members may be one, three, or more. In a case where there is one intermediate member, the intermediate member may be made of a material with lower thermal conductivity than that of the installation portion 405 in order to suppress the inflow of heat from the main substrate 302. In a case where there are three or more intermediate members, the thermal conductivity of the intermediate member closest to the main substrate 302 among the intermediate members can be lower than that of each of the other intermediate members, and the inflow of heat from the main substrate 302 can be suppressed.

As discussed above, the structure according to this embodiment can secure a sufficient heat dissipation area and electrical characteristics, while reducing the noise influence caused by the generation of stray capacitance Cs, even in electronic apparatuses in which conductors inside a substrate face off against nearby conductors.

In order to set the thermal resistance R between the antenna substrate 401 and the main substrate 302 higher than that between the antenna substrate 401 and the installation portion 405, the cross-sectional area of the thermal connector 406 in the heat transfer direction may be smaller than that of the installation portion 405. The thermal connector 406 between the antenna substrate 401 and the main substrate 302 may be made longer than the installation portion 405 so as to increase the heat path. In this case, the contact thermal resistance can be increased by placing an additional intermediate member in addition to the first intermediate member 408 and the second intermediate member 414.

In this embodiment, the installation portion 405, heat dissipation portion 404, and thermal connector 406 are provided on the heat dissipation sheet metal 403, but each of them may be provided on separate sheet metal and they may be thermally connected by fastening screws or the like.

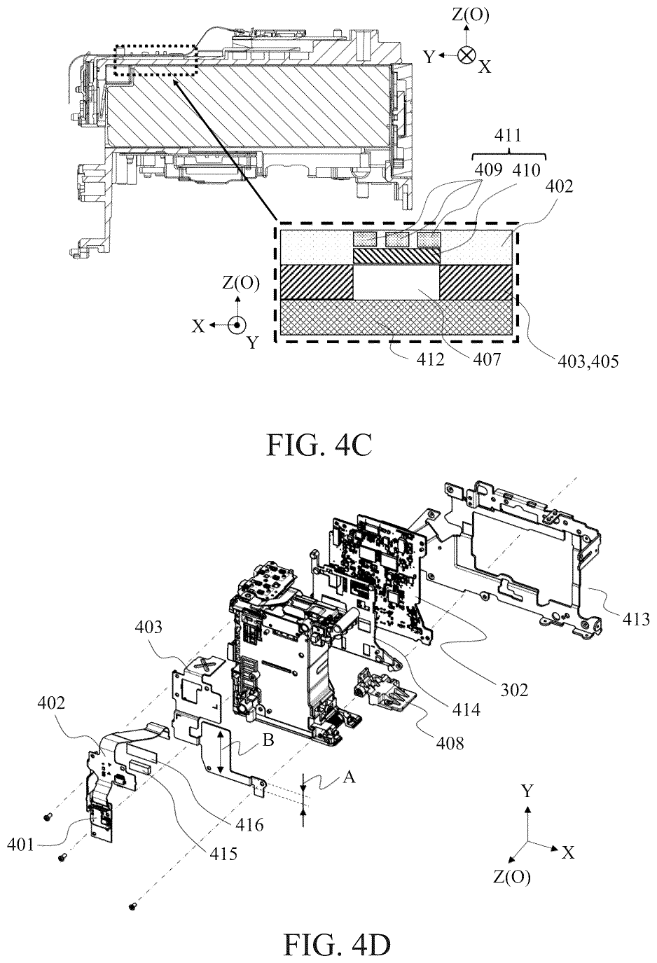

FIGS. 5A and 5B explain the battery chamber unit 304. FIG. 5A is a front view of the battery chamber unit 304. FIG. 5B is a sectional view taken along a line Y-Y′ in FIG. 5A and an enlarged cross section. The enlarged cross section of FIG. 5B omit components that are not directly related to the generation of stray capacitance between conductors, such as the antenna substrate, main substrate, thermal connector, and intermediate members, for simple illustration and easy understanding.

In FIGS. 4A, 4B, 4C, and 4D, the heat dissipation sheet metal 403 serves as a heat dissipation path and an electromagnetic shield, and an opening 407 is provided in the heat dissipation sheet metal 403 at a position facing the conductor layer 411 of the connection substrate 402 in order to reduce the generation of stray capacitance Cs. In addition to the above roles, the heat dissipation sheet metal 403 also serves to fix the connection substrate 402 to the installation portion 405 with double-sided tape or the like, so as to suppress contact with surrounding components and electrical disconnections from the main substrate 302 and the antenna substrate 401 that may occur due to vibration or impact. Therefore, if the opening 407 is provided in the installation portion 405 to reduce the generation of stray capacitance Cs, the adhesive area for adhesively fixing the connection substrate 402 with double-sided tape or the like will be reduced, and the connection substrate 402 may come into contact with surrounding components or the electrical disconnections may occur due to impact.

Accordingly, as illustrated in FIG. 5A, the battery chamber 412 may have a convex shape (or convex portino) 501 that is positioned inside the opening 407 and secures the connection substrate 402. By configuring the convex shape 501 to fill the opening 407 in the assembled state, an area for fixing the connection substrate 402 with double-sided tape or the like can be secured. At that time, as illustrated in FIG. 5B, the height (position) in the Z-direction of the top surface portion (tip portion) of the convex shape 501 and the top surface portion (surface that fixes the connection substrate 402) of the installation portion 405 may coincide with each other in a direction in which the installation portion 405 fixes the connection substrate 402. Here, “coincide” includes a case in which they substantially (approximately) coincide with each other. Furthermore, as discussed above, if the conductors face each other, stray capacitance Cs may occur and thus the convex shape 501 may be made of a nonconductive material; in this embodiment, it is made of a nonconductive molding material.

### Second Embodiment

The basic structure of a digital camera according to this embodiment is similar to that of the digital camera 100 according to the first embodiment. This embodiment will discuss only the differences from the first embodiment, and will omit a description of the common configuration.

In order to reduce noise caused by stray capacitance Cs, as illustrated in FIG. 4C, the first embodiment provides the opening 407 in the heat dissipation sheet metal 403 at a position facing the conductor layer 411 of the connection substrate 402, whereas this embodiment forms an insulating layer between the conductors.

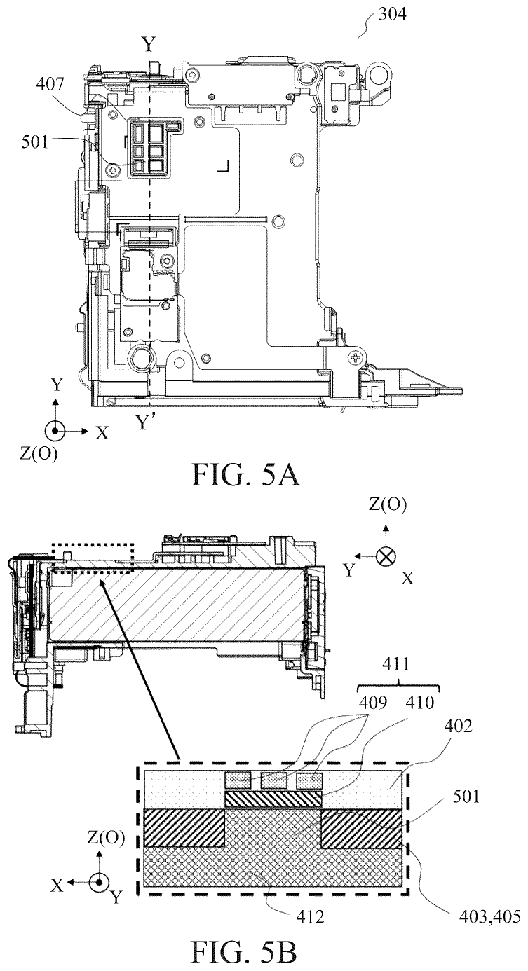

FIG. 6 explains a battery chamber unit, illustrating another example of the enlarged cross-section illustrated in FIG. 4C, different from that of the first embodiment. FIG. 6 omits components not directly related to the generation of stray capacitance between conductors, such as the antenna substrate, main substrate, thermal connector, and intermediate members, for simple illustration and easy understanding.

Heat dissipation sheet metal 601 is supported and fixed by a battery chamber 602. A connection substrate 603 is positioned close to and opposite to the heat dissipation sheet metal 601. In this embodiment, the connection substrate 603 is a FPC. The connection substrate 603 has a conductor layer 606 including a signal pattern 604 and a GND pattern 605. An insulating layer 607 is positioned between the heat dissipation sheet metal 601 and a conductor layer 606. By placing the insulating layer 607, a distance d1 between the conductors can be increased, and the stray capacitance Cs can be reduced. In this embodiment, the insulating layer 607 is a reinforcing plate formed on the connection substrate 603, which is an FPC.

The insulating layer 607 may be an insulator rather than simply creating an air layer. Insulators do not conduct electricity and can block electric fields, and thus serve to reduce direct electrical coupling between conductors. Furthermore, sandwiching an insulator between the conductors maintains the distance d1 constant, and improves the stability of the insulation state. Thereby, the EMI characteristics can be improved and noise generation can be suppressed.

### Third Embodiment

The basic structure of a digital camera according to this embodiment is similar to that of the digital camera 100 according to the first embodiment. This embodiment will discuss only the differences from the first embodiment, and will omit a description of the common components.

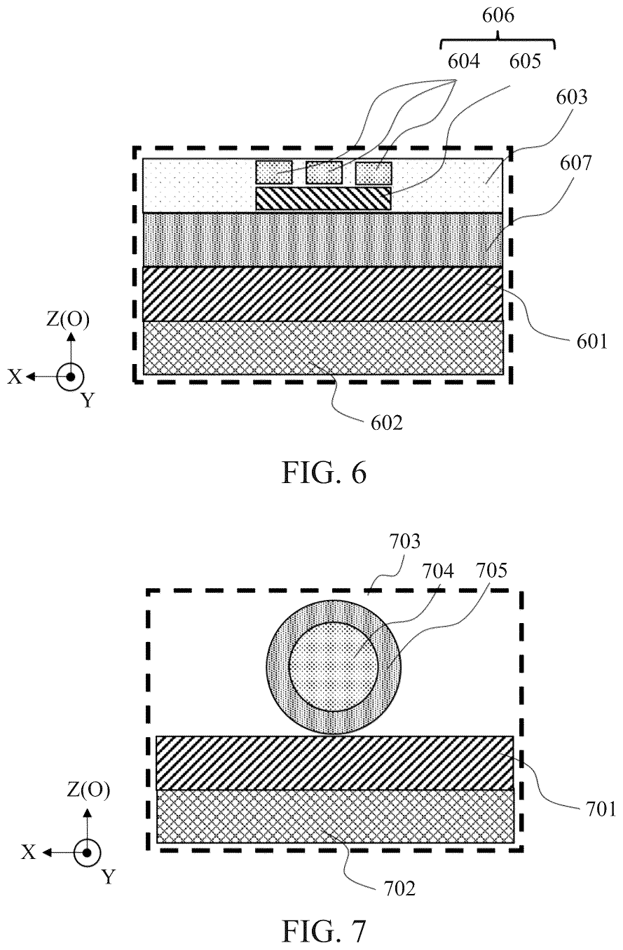

FIG. 7 explains a battery chamber unit, illustrating another example of the enlarged cross-section illustrated in FIG. 4C, different from that of the first embodiment. FIG. 7 omits components not directly related to the generation of stray capacitance between conductors, such as the antenna substrate, main substrate, thermal connector, and intermediate members, for simple illustration and easy understanding.

Heat dissipation sheet metal 701 is supported and fixed by a battery chamber 702. A connection substrate 703 is positioned close to and opposite to the heat dissipation sheet metal 701. In this embodiment, the connection substrate 703 is a coaxial cable. The connection substrate 703 includes at least one conductor 704 and an insulating coating (insulating layer) 705 that covers the conductor 704. The conductor 704 is made of a metal with low electrical resistance, such as copper or aluminum. The insulating coating 705 may be made of an insulating material, such as polyvinyl chloride or polyurethane. Even when a plurality of connection substrates 703 are disposed near the heat dissipation sheet metal 701, the insulating coating 705 can suppress the generation of stray capacitance Cs between the connection substrates 703 and the heat dissipation sheet metal 701.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an electronic apparatus that can suppress deterioration of radio wave characteristics while maintaining heat dissipation performance.

This application claims the benefit of Japanese Patent Application No. 2024-227781, filed on Dec. 24, 2024, which is hereby incorporated by reference herein in its entirety.

What is claimed is:

1. An electronic apparatus comprising:
a circuit board;
a control board configured to control the circuit board;
a connecting component including a conductor layer that electrically connects the circuit board and the control board; and
sheet metal thermally connected to the circuit board and having a fixing portion that fixes the connecting component,
wherein an opening is provided in an area of the fixing portion facing the conductor layer,
wherein the sheet metal includes at least one thermal connector that electrically and thermally connects the circuit board and the control board, and
wherein thermal resistance between the circuit board and the control board is higher than that between the circuit board and the fixing portion.

2. The electronic apparatus according to claim 1, wherein the circuit board is a printed circuit board including an antenna circuit and an integrated circuit.

3. The electronic apparatus according to claim 1, wherein the connecting component is a flexible printed circuit.

4. The electronic apparatus according to claim 1, further comprising a structure that fixes the control board and the sheet metal,
wherein the structure has a convex portion that is disposed inside the opening and fixes the connecting component.

5. The electronic apparatus according to claim 4, wherein a position of a tip portion of the convex portion coincides with a position of the fixing portion for fixing the connecting component in a direction in which the fixing portion fixes the connecting component.

6. The electronic apparatus according to claim 1, wherein the sheet metal includes a heat dissipation portion disposed between the circuit board and the thermal connector, and
wherein thermal resistance of the heat dissipation portion is smaller than that of the thermal connector.

7. The electronic apparatus according to claim 6, wherein a heat capacity of the heat dissipation portion is larger than that of the fixing portion.

8. The electronic apparatus according to claim 1, further comprising at least one intermediate member that thermally connects the thermal connector and the control board,
wherein the at least one intermediate member is disposed between the thermal connector and the control board.

9. The electronic apparatus according to claim 8, wherein the at least one intermediate member includes an intermediate member having a thermal conductivity lower than that of the thermal connector.

10. The electronic apparatus according to claim 8, wherein the at least one intermediate member includes an intermediate member having a thermal conductivity lower than that of the fixing portion.

11. The electronic apparatus according to claim 1, wherein a cross-sectional area of the at least one thermal connector in a heat transfer direction between the circuit board and the control board is smaller than that of the fixing portion in the heat transfer direction between the circuit board and the control board.

12. The electronic apparatus according to claim 1, wherein a distance in a heat transfer direction between the circuit board and the control board in the at least one thermal connector is longer than a distance in the heat transfer direction between the circuit board and the control board in the fixing portion.

13. An electronic apparatus comprising:
a circuit board;
a control board configured to control the circuit board;
a connecting component including a conductor layer that electrically connects the circuit board and the control board;
sheet metal thermally connected to the circuit board and having a fixing portion that fixes the connecting component; and
an insulating layer disposed between the conductor layer and an area of the fixing portion facing the conductor layer,
wherein the sheet metal includes at least one thermal connector that electrically and thermally connects the circuit board and the control board, and
wherein thermal resistance between the circuit board and the control board is higher than that between the circuit board and the fixing portion.

14. The electronic apparatus according to claim 13, wherein the connecting component is a flexible printed circuit, and
wherein the insulating layer is a reinforcing plate formed on the flexible printed circuit.

15. The electronic apparatus according to claim 13, wherein the connecting component is a coaxial cable, and
wherein the insulating layer is a coating layer that covers the coaxial cable.
